(19) United States
(12) Patent Application Publication
(10) Pub. No.: US 2015/0213909 A1
(43) Pub. Date: Jul. 30, 2015

(54) Interpenetrating Radiation Shield

(71) Applicant: Analytical Services and Materials, Inc., Hampton, VA (US)

(72) Inventors: Karl Erik Wiedemann, Seaford, VA (US); Rajagopalan Sivakumar, Yorktown, VA (US)

(73) Assignee: Analytical Services and Materials, Inc., Hampton, VA (US)

(21) Appl. No.: 14/604,154

(22) Filed: Jan. 23, 2015

Related U.S. Application Data
(60) Provisional application No. 61/931,021, filed on Jan. 24, 2014.

(51) Int. Cl. G21F 1/00

(52) U.S. Cl. CPC G21F 1/00

(57) ABSTRACT

An interpenetrating radiation shield is presented. The shield comprises an active shield and at least one passive shield. The active shield generates a directional active shield field. The passive shield has an areal density ranging from about 1 g/cm² to about 1000 g/cm² and is positioned within the active shield field in a relationship to the active shield wherein a radiation particle having kinetic energy and traversing a path at a rate of speed is deflected by the active shield field as the radiation particle enters the passive shield. The path of the radiation particle is lengthened within the passive shield and the kinetic energy and speed of the radiation particle are decreased within the passive shield.

### CROSS REFERENCE TO RELATED APPLICATIONS

This application claims the benefit of U.S. Provisional Patent Application Ser. No. 61/931,021, entitled, “Interpenetrating Radiation Shield,” filed Jan. 24, 2014, which is hereby incorporated by reference in its entirety.

### FIELD OF THE INVENTION

This invention relates to radiation shielding. In particular, it relates to using an active shield and a passive shield together in the same space to control radiation exposure.

### BACKGROUND OF THE INVENTION

As radiation passes through matter it may have immediate and lasting effects including the deposition of radiation energy. The effects may be deleterious to beings and objects composed of matter (radiation sinks) and may result in death, disease, impairment, destruction and improper function. It is not always possible to eliminate radiation at its source and in such cases it is necessary to protect sensitive targets, i.e. beings and objects sensitive to radiation, by turning the radiation away or attenuating it before it reaches sensitive radiation sinks.

Radiation is composed of small fragments of matter which may, or may not, have mass and when observed by various means may be seen to behave as particles or as waves. Examples of radiation are: visible light, x rays, and cosmic rays. Radiation is energetic. It transports energy from a radiation source and deposits it in a radiation sink. In the case of cosmic rays, it is possible that the source and sink lie at opposite ends of the universe. Radiation may be penetrating and it may pass deeply into or possibly completely through matter. As radiation passes through matter, it may undergo changes in composition and energy. The radiation energy is generally in the form of kinetic energy but may take on latent forms such as excited states and unstable forms of subatomic matter.

The radiation sink may also undergo changes in composition and energy. Deposited energy is generally in the form of ionization and thermal energy, but may also take on latent forms such as excited states, unstable forms of subatomic matter, and induced radioactivity. The changes in composition of the sink may be destructive such as the breaking of chemical bonds in DNA. Such changes could threaten the life and health of beings when they are radiation sinks. Energy deposited in the sink may also result in the improper function of electronic devices such as digital processors where ionization may alter memory or interfere with logic circuits.

Physical fields such as gravity, electrostatic fields, and magnetic fields are examples of fields capable of diverting the path of radiation. In the past, radiation shielding schemes have relied upon either active or passive means of radiation shielding. The active means has been applied as the first line of defense to divert radiation. Active shielding works by deflecting the path of radiation. Its success is limited by its ability to turn the radiation sufficiently within the distance over which the field has force such that the radiation will not hit sheltered radiation sinks. This ability depends upon the strength of the field, the distance over which the field acts, and the rigidity of the radiation particle. Higher energy radiation particles tend to have greater rigidities and are thus more difficult to divert using active shielding. Active shields have the defects of creating lens-like effects because the deflection action can function to focus radiation particles that would have otherwise missed the sensitive target and to direct them toward the sensitive target. This deflection action can trap radiation particles, creating a radiation storage condition that increases the amount of radiation in the vicinity of the sensitive target. Passive shields have been separately applied as a backup to active shielding to catch radiation that made it through the active shielding. This was done in the belief that it was better to deflect the radiation before it encountered any passive shielding where it would likely generate secondary radiation such as gamma rays and neutrons that could not be diverted by active fields. Passive shielding attenuates radiation by slowing and moderating it, resulting in the deposition of the radiation's energy in the passive shield and possibly resulting in the complete capture and absorption of the radiation. The process by which this occurs is complex and may involve many forms of interaction at many energy levels. For instance, cosmic radiation is principally composed of high-energy protons. When a high-energy proton passes through matter it may produce electromagnetic cascades of electrons, gamma rays and ionized particles. It may also produce hadronic cascades of neutral and charged particles such as secondary protons, neutrons, alpha particles, pions and kaons. In the process of producing the showers, the energy of the primary cosmic ray proton is distributed to the resulting cascades of secondary radiation. The secondary radiation particles have less kinetic energy than the original primary and are thus generally less rigid and more easily absorbed by additional passive shielding and more easily deflected by subsequently encountered active shielding. The success of passive shielding depends upon the stopping power (a composite measure of the cross-sections of physical interaction processes) of the shielding and the length of the path traveled by the radiation through the shielding. The longer the path that the radiation travels, the greater is the opportunity for the passive shielding to moderate and absorb the radiation. The difficulty is one of constructing a path of sufficient length because radiation tends to travel in a straight line and thus longer paths imply more massive shielding. Prior to the present invention, passive shielding and active shielding were not used synergistically to form a shield because the shielding effects ran counter to each other and the result was that of radiation particles passing through both shields in turn because the effects of the two were not additive. As a result, radiation passing through the active shield was no more susceptible to passive shield effects than it was before passing through the active shield.

### SUMMARY OF THE INVENTION

An object of the present invention is to provide improved radiation shielding by employing active and passive shielding together to protect the same space.

Another object of the present invention is to reduce the required mass of the passive shielding and the required field strength of the active shielding.

By the present invention, an interpenetrating radiation shield is presented. The interpenetrating shield comprises an active shield and at least one passive shield. The active shield generates a directional active shield field. The passive shield is positioned within the active shield field in an operational relationship to the active shield. As a radiation particle having kinetic energy traverses a path at a rate of speed, it is deflected by the active shield field as the radiation particle enters the passive shield. The passive shield has an areal density ranging from about 1 g/cm² to about 1000 g/cm². As the radiation particle travels through the passive shield, the path of the radiation particle is lengthened, and the kinetic energy of the radiation particle and the speed of the radiation particle are decreased. Several further events can occur once the radiation particle enters the passive shield. The radiation particle may be ablated within the passive shield. Alternatively the interaction between the active shield field and the passive shield may be such that the path of the radiation particle is directed out of the passive shield by the active shield field. Conversely, the path of the radiation particle within the passive shield is directed further into the passive shield by the active shield field. In yet another embodiment, the radiation particle is captured within the passive shield.

Additional objects and advantages of the invention will be set forth in part in the description which follows, and in part, will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

FIG. 1A depicts the interpenetrating shield of the present invention with respect to a radiation environment and radiation sinks.

FIG. 1B depicts the effect of the interpenetrating shield on the path of a radiation particle.

FIG. 2A depicts the interpenetrating shield of the present invention in combination with an external passive shield and an internal passive shield.

FIG. 2B depicts the interpenetrating shield of the present invention having a segmented active shield in combination with an external passive shield.

FIG. 2C depicts the interpenetrating shield of the present invention having a segmented passive shield disposed within an active shield field.

FIG. 3 depicts the interpenetrating shield of the present invention surrounded by an outer passive shield and having compartments defined by a plurality of inner passive shields.

FIG. 4 depicts the interpenetrating shield of the present invention in a toroidal configuration having a series of interpenetrating shields surrounded by a series of passive shields.

### DETAILED DESCRIPTION OF THE PREFERRED EMBODIMENTS

The interpenetrating radiation shield of the present invention provides shielding in environments where the types and levels of radiation harm sensitive radiation sinks. At a minimum, the radiation environment comprises levels greater than 0.01 rems per year equivalent dose and can be between 0.02 and 0.12 rems per year. The equivalent dose typically encountered in jetliner aviation is approximately 2.8 rems per year. Low earth orbit sees a radiation environment of approximately 10 rems per year equivalent dose with the lunar surface having an equivalent dose of 7 to 12 rems per year. During interplanetary spaceflight the equivalent dose is up to 25 rems per year. Typically, the radiation energy in the radiation environment is primarily in the form of protons. Therefore, it is desirable to have a system that will block or deflect this form of radiation from sensitive radiation sinks.

Referring now to the drawings where similar elements are numbered the same throughout, for ease of reading, the following listing is provided:
10—Interpenetrating shield of the present invention
11—Radiation
12—Active Shield
14—Active Shield Field—shown by cross-hatched background
15—Radiation Particle
16—Passive Shield—shown by dotted background
17—Radiation Particle Path
20—Outer (Pre-Active) Passive Shield
30—Segmented Active Shield
40—Inner (Post-Active) Passive Shield
50—Enclosed Space
60—Radiation Sink
70—Radiation Absorber

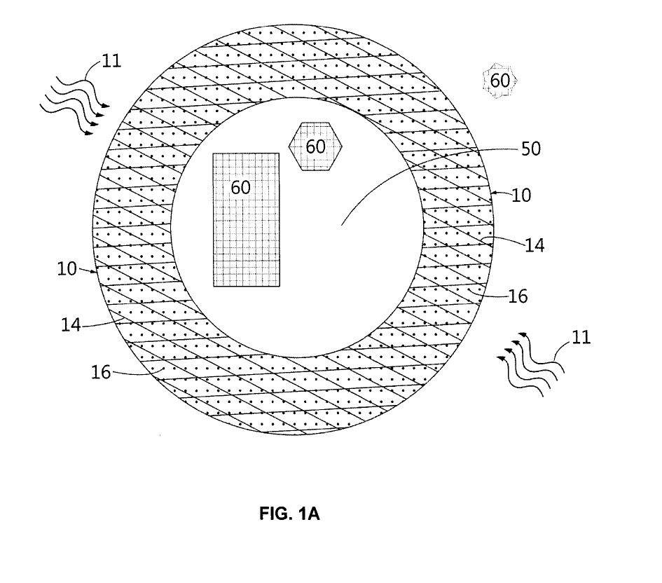

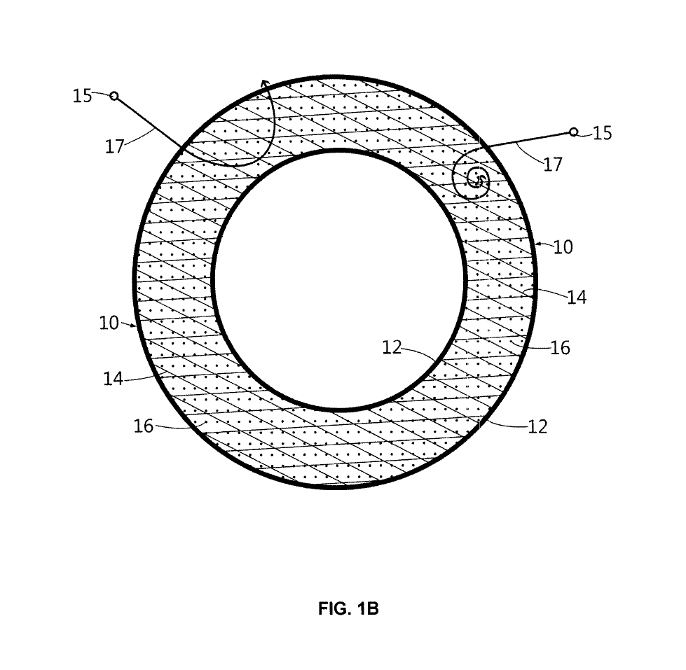

FIG. 1A depicts one configuration of the present invention, showing the interpenetrating shield 10 with respect to radiation sinks 60 in an enclosed space 50. In this configuration, the interpenetrating shield 10 comprises active 14 and passive 16 shielding elements to protect various radiation sinks 60 located in a nearby space or enclosed space 50 from the effects of radiation 11. The interpenetrating shield 10 is able to protect radiation sinks 60 that are not inside the enclosed space 50 as long as the radiation sink 60 is positioned in an operable relationship to the interpenetrating shield 10 such that the radiation sink 60 will experience a shadow effect created by the interpenetrating shield 10. The radiation 11 environment is spherically isotropic, hemispherically isotropic or directional.

FIG. 1B shows that the interpenetrating shield 10 comprises an active shield 12 which generates a directional active shield field 14. The active shield field 14 is selected from the group consisting of: an electrostatic field and a magnetic field and may also be a combined electrostatic and magnetic field. Any means known to generate an electrostatic or magnetic field may be used in the present invention. Examples of magnetic field generators include but are not limited to solenoids or superconductive materials. Electrostatic fields are typically generated using monopole positive electrostatic potential barriers and current-carrying superconducting solenoids. The interpenetrating shield of the present invention requires that at least one passive shield 16 is positioned within the active shield field 14. The passive shield 16 has an areal density ranging from about 1 g/cm² to about 1000 g/cm². FIG. 1B depicts what happens as a radiation particle 15 encounters the interpenetrating shield 10. In one embodiment, the radiation particle 15 enters into the interpenetrating shield 10 and the active shield field 14 deflects the radiation particle 15 changing the radiation particle path 17 as it enters into the passive shield 16. This deflection results in the length of radiation particle path 17 increasing and the kinetic energy and speed of the radiation particle 15 being decreased within the passive shield 16. This invention differs from the prior art in that the passive shield 16 lies within the active shield field 14. In contrast, Cummings in U.S. Pat. No. 5,324,952 discloses the need to layer different shield materials, wherein the ordering of the layers is with respect to incident radiation and is selected to provide desired proton and/or neutron radiation attenuation characteristics. The present invention reduces the need to layer different shield materials or have multiple shield layers.

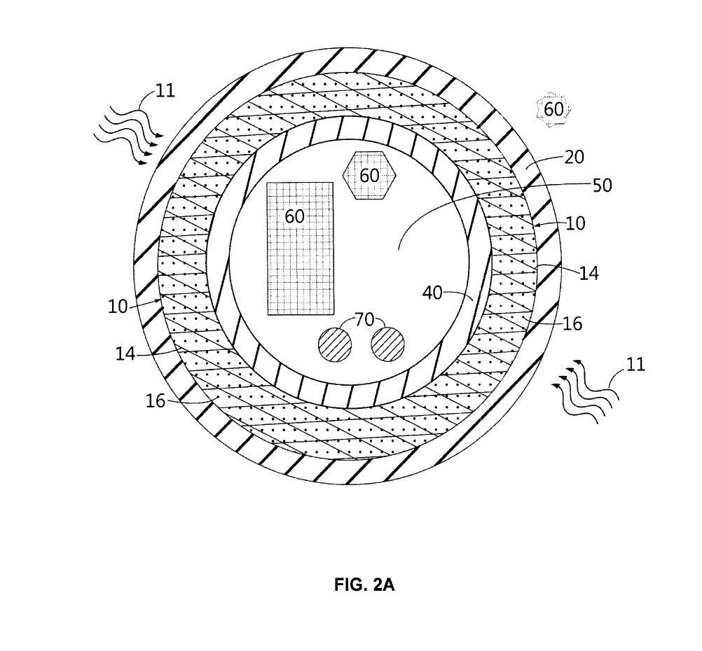

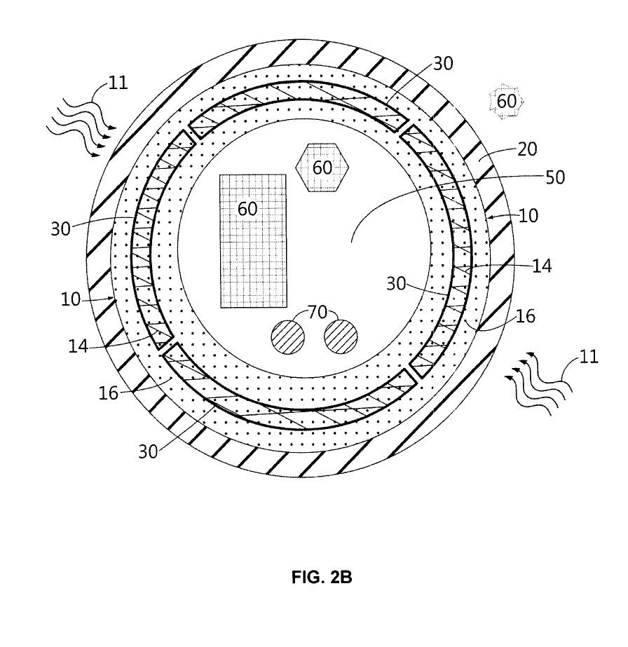

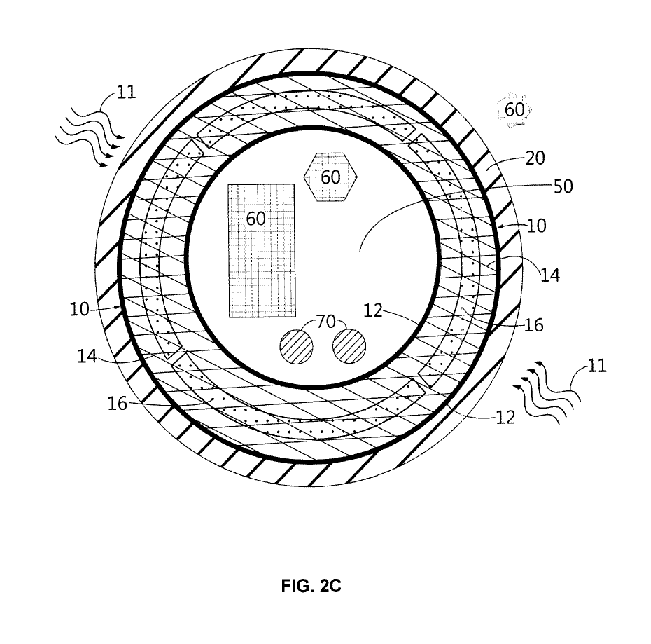

The active shield fields 14 may be continuous or they may be broken into discrete segments 30 as shown in FIG. 2B. In addition, the strength of the active shield field 14 is either uniform or varies with location. Preferably, the active shield field 14 component comprises a magnetic field. In general, the field strength of the field at its strongest point is greater than 0.1 Gauss. The active component is a tube or a shell having a minimum thickness of 1 cm. The effectiveness of the active component in this embodiment depends on thickness and field strength. Greater thicknesses and greater field strengths improve effectiveness. In another embodiment, the thickness is at least 100 cm and the field strength at its strongest point is at least 10 Gauss. In yet another embodiment, the field strength is at least 500 Gauss. When activated, the segmented active shield 30 emits either an electrostatic or magnetic field 14. Active shielding works by deflecting the path of radiation. Its success is limited by its ability to turn the radiation sufficiently within the distance over which the field has force such that the radiation will not hit sheltered radiation sinks. This ability depends upon the strength of the field, the distance over which the field acts, and the rigidity of the particle. Higher energy particles tend to have greater rigidities and are thus more difficult to divert using active shielding. Therefore, by introducing passive shielding 16 distributed throughout the directional active shield field 14 to form the interpenetrating shield 10, protons from the radiation field 11 are slowed as they pass through the passive shield 16, lose their rigidity, and are caused to spiral inward on themselves or to be directed out of the passive shield 16 back in the direction they came from due to the active shield field 14 emissions, allowing the radiation sinks 60 to remain protected. In some instances, the radiation particle 15 is ablated within the passive shield 16. Alternatively, the radiation particle 15 is captured within the passive shield and travels along a path in the passive shield 16. (See FIG. 1B.)

The passive shield 16 has an areal density ranging from about 1 g/cm² to about 1000 g/cm². The passive shield 16 comprises a quantity of matter which is either composed of multiple layers or substructure and is either fully or partially enclosed in stray fields 14 emanating from the segmented active shielding 30. The composition and thickness of the passive shield 16 may vary locally, but preferably is selected from the group consisting of: a solid, a liquid, and a gas. The interpenetrating shield 10 of the present invention comprises a combination of matter serving as a passive shield 16 and active shield fields 14 including deliberately applied fields as well as stray fields that emanate from the segmented active shielding 30. FIGS. 1A and 1B depict one embodiment of the present invention where the entire passive shielding 16 is contained within the field emitted by the active shielding. FIG. 2B depicts another embodiment where the interpenetrating shield 10 is formed by the passive shielding 16 filling gaps within the field 14 emitted by the segmented active shielding 30. FIGS. 2A-4 show embodiments where an outer pre-active passive shield 20 surrounds the interpenetrating shield 10. Ideally, the outer pre-active passive shield 20 limits the active shield field 14, but it is understood that stray fields may emanate from the active shielding 12 and segmented active shielding 30. FIGS. 2A-4 depict an embodiment where the outer pre-active passive shield 20 is placed between the radiation environment 11 and the interpenetrating shield 10 such that radiation particles from the radiation environment 11 first pass through the outer pre-active passive shield 20 where the radiation particles are weakened and degraded by passage through the outer pre-active passive shielding 20 making the radiation particles less rigid and hence more easily deflected by the subsequently encountered field emitted by the active shield field 14 in the interpenetrating shield 10.

FIGS. 2A, 3 and 4 depict another embodiment where two passive shields 20, 40 are used in combination with the interpenetrating shield 10. An outer (or pre-active) passive shield 20 surrounds the interpenetrating shield 10 serving as an additional shield to the radiation environment 11 and an inner (or post-active) passive shield 40 surrounds the radiation sinks 60. FIG. 2C depicts an embodiment where the passive shield 16 is segmented.

The effectiveness of the passive shielding depends upon the mass per unit area of the passive shielding. In one embodiment of the invention the mass per unit area is less than 1000 g/cm². In another embodiment of the invention, the mass per unit area ranges from at least 5 g/cm² to less than 500 g/cm². When the radiation environment comprises protons having kinetic energies of 20 GeV, about 316 g/cm² of a polymeric material such as, polyethylene, are required to stop 95% of the primary protons. Where the total weight of the radiation shielding must be limited, the mass per unit area ranges from at least 8 g/cm² to less than 210 g/cm².

One example of passive shielding is matter in the form of a solid. The solid is in the form of a foam with interconnecting porosity. One type of foam that is suitable has closed cells. Alternatively, the foam is syntactic and able to be stored and transported in a compressed form and then expanded for deployment. While the effectiveness of the passive shielding improves with greater density, greater density also contributes to the total weight of the system. Therefore, in systems where weight is a critical factor, the total amount of matter that can be placed into the passive shielding may be limited. However, the effectiveness of the passive shielding within the interpenetrating shielding depends on the distribution of matter. In one embodiment, the distribution of matter throughout the interpenetrating shielding is essentially uniform to allow the greatest extension of radiation path length afforded by the active shielding's deflection of the radiation path. A foam solid is used to provide an essentially uniform distribution of matter while limiting total weight by selecting appropriate density foams. In one example, the density of the foam is between 0.005 and 0.015 g/cm³. In another, the density of the foam is between 0.015 and 0.075 g/cm³. In another, the density of the foam is between 0.075 and 0.500 g/cm³ and in another, the density of the foam is between 0.500 g/cm³ and 4.00 g/cm³. In one embodiment, the foam is a polyurethane foam with a density of 0.010 g/cm³. In another embodiment the foam is a polyethylene foam with a density of 0.01 to 0.07 g/cm³. In another embodiment, the foam is a boron-carbide foam with a density of 400 g/cm3 and in another, the foam is a ferromagnetic dispersion in a polyurethane foam with a density of 1 to 1.6 g/cm³. In another embodiment, the foam is an aluminum alloy with a density of 0.3 to 0.5 g/cm³. In another embodiment, the foam is a nano-carbon foam with a density of 0.007 to 0.015 g/cm³.

As an alternative embodiment, the passive shielding is a gas. The density of the gas is greater than 1×10⁻²⁰ g/cm³. The effectiveness of the passive shielding depends on the density of the gas with greater densities giving greater effectiveness. In this embodiment, the gas has a density of at least 1×10⁻⁴ g/cm³ and in another embodiment, the gas has a density of at least 1×10⁻³ g/cm³. By way of example, the gas is air at standard temperature and pressure with a density between 1.0×10⁻³ and 1.4×10⁻³ g/cm³.

In another embodiment, the passive shielding is a liquid. The density of the liquid is at least 0.06 g/cm³. In one embodiment, the liquid has a density of greater than 0.5 g/cm³. In another embodiment, the density of the liquid ranges from about 0.7 to about 2.0 g/cm³. By way of example, the liquid is hydrogen with a density between 0.07 and 0.075 g/cm³. Alternatively, the liquid is hexadecane with a density of 0.7 to 0.75 g/cm³. In yet another example, the liquid is water with a density between 0.9 and 1.3 g/cm³.

FIGS. 1A, and 2A-4 depict a sheltered space 50 which is partially or hermetically enclosed by the interpenetrating shield 10 and/or an inner post-active passive shield 40. Within this enclosed space 50, sensitive radiation sinks 60 such as beings and objects composed of matter that are vulnerable or sensitive to radiation may be disposed along with other objects such as additional radiation shielding and/or radiation absorbers 70. The additional radiation shielding and/or radiation absorbers 70 are active or passive radiation shields or the interpenetrating radiation shield of this invention.

In use, the radiation shielding 10, 20 is disposed on the surface of a large body such as a man-made structure or a natural structure such as the earth, the moon, a planet, an asteroid, or a comet. Alternatively, the radiation shielding 10, 20, 40 is entirely submerged in the surface of the large body. The passive shielding of the interpenetrating radiation shield are formed from the matrix of the large body where the matrix comprises water, ice, dirt, rocks, regolith, liquefied gases and vegetation.

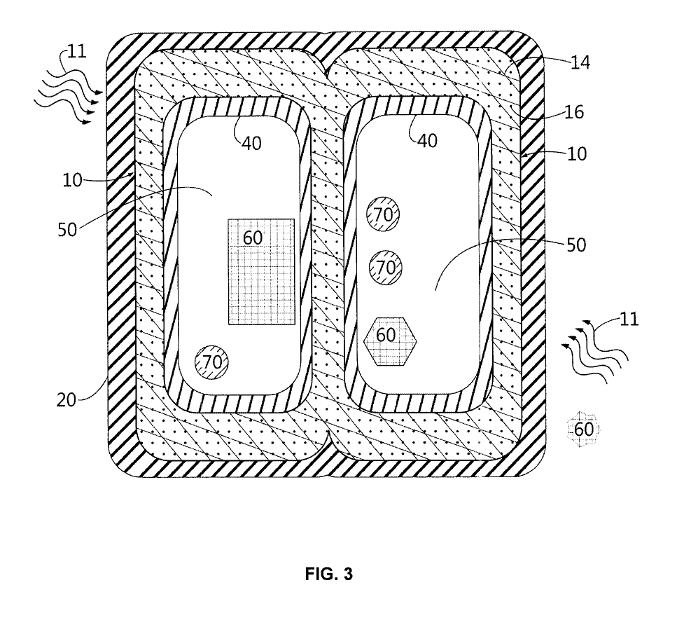

FIG. 3 depicts the interpenetrating radiation shield 10 passing between partially or hermetically enclosed shelter spaces 50. Radiation 11 first encounters a passive shield 20 surrounding the interpenetrating radiation shield 10 which is comprised of the active field 14 and the passive shield 16. An inner passive shield 40 surrounds and defines a divided enclosed shelter space 50. The shelter space 50 contains the radiation sinks 60 and an additional internal radiation shield 70. This additional internal radiation shield 70 is either an active shield, passive shield, or the interpenetrating radiation shield of the present invention.

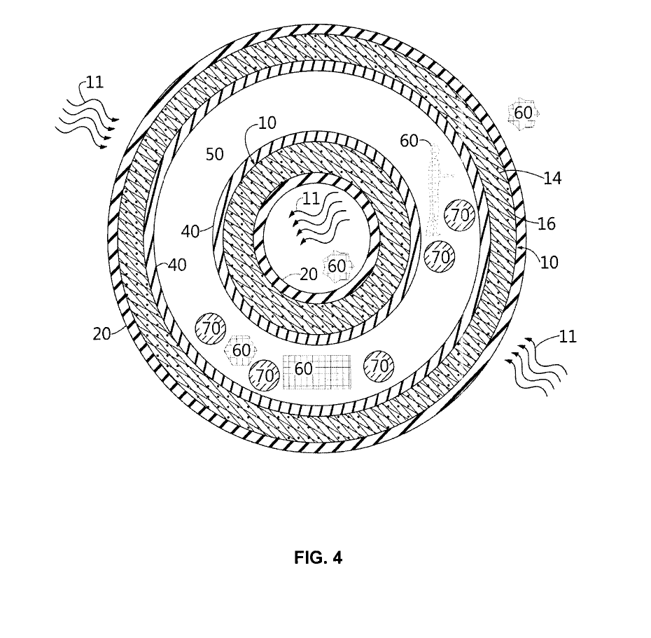

FIG. 4 depicts a toroidal or tower-like configuration which protects against a radiation environment 11 using a plurality of interpenetrating radiation shields 10 comprising an active shield field 14 and a passive shield 16, two inner passive radiation shields 40 which define a sheltered space 50 containing radiation sinks 60 (such as a human being), and two outer passive radiation shields 20. Also within the sheltered space 50 are additional internal radiation shields 70.

In a most preferred embodiment of the invention, the interpenetrating radiation shield comprises a magnetic active shield comprising a shell having a thickness of at least 100 cm and a field strength of at least 10 Gauss. The magnetic active shield generates a directional magnetic field. A foam passive shield having an areal density ranging from about 1 g/cm² to about 1000 g/cm² is equally distributed throughout the magnetic active shield field. A radiation particle having kinetic energy traverses a path at a rate of speed and is deflected by the active shield magnetic field as the radiation particle enters the foam passive shield. The path of the radiation particle is lengthened within the foam passive shield. The kinetic energy of the radiation particle and the speed of the radiation particle are decreased within the foam passive shield.

### EXAMPLE

The effectiveness of different shielding options was evaluated using a radiation modeling application program built on the GEANT 4 physics-based toolkit software. The radiation modeling application program is commercially available for licensing from Analytical Services & Materials, Inc. 107 Research Drive, Hampton, Va. 23666. A radial hall with 150 centimeters thick of shielding containing a Human figure simulant at the center of the interior space was constructed. Galactic cosmic ray spectrum containing particles from protons to heavy ions up to iron in energy range from 10 keV (kilo electron volts) to 100 TeV (tera electron volts) were sprayed from the outside the radial hall into the interior space passing through no shield (#1), only active shield (#2 and #3), only passive shield (#4) and the interpenetrating shield of the present invention (#5 and #6). The deposited energy in Human simulant is reported as annual dose in milligray per year and the biological effectiveness of the radiation is reported in millisieverts per year using the factors given in the International Commission on Radiological Protection (ICRP) publication 103. The results are shown in Table 1.

TABLE 1

| | | | Annual Dose |
|---|---|---|---|
| | | | Equivalent in |
| | | Annual Does in | Millisieverts/year |
| | | Milligrays/year | in |
| Num- | | in | Human Simulant |
| ber | Shield Features | Human Simulant | (ICRP 103) |
| 1 | No shield | 115 | 1016 |
| 2 | Active Shield (magnetic) | 123 | 1134 |
| | 2 Tesla | | |
| 3 | Active Shield (magnetic) | 77 | 688 |
| | 5 Tesla | | |
| 4 | Polyethylene Foam Passive | 68 | 326 |
| | Shield 0.2 grams/cc density | | |
| 5 | Interpenetrating Shield of | 47 | 214 |
| | 5 Tesla Active Magnetic | | |
| | Shield and Polyethylene | | |
| | Foam (0.2 grams/cc) | | |
| 6 | Interpenetrating Shield of | 67 | 531 |
| | 5 Tesla Active Magnetic | | |
| | Shield and Polyethylene | | |
| | Foam (0.02 grams/cc) | | |

The results showed an unexpected slight increase in the dose when the only shielding used is an active magnetic field of 2 Tesla (#2) as compared to the case of no shielding (#1), indicating that low magnetic field shielding may actually be harmful to various radiation sinks. When the field strength of the magnetic active shield was increased to 5 Tesla (#3), the annual dose was reduced from 115 to 77 milligrays. When only a passive shield of 0.2 grams/cc dense Polyethylene foam (#4) was used, the dose was lower as compared to the active magnetic shield of 5 Tesla (#3). The unexpected result of the lowest annual dose of 47.0 milligrays was obtained for the interpenetrating shield comprised of Polyethylene foam of 0.2 grams/cc density used as the passive shielding that was contained inside the active magnetic shield field of 5 Tesla. Thus, this combination for the interpenetrating shield was the most effective as compared to either of the active or passive shield acting alone. However, when the passive shield Polyethylene foam density was reduced from 0.2 to 0.02 grams/cc (#6), the dose increased. The experimental results indicate that an interpenetrating shield is more effective against harmful radiation than using a prior art “stacked” shield configuration.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

What is claimed is:

1. An interpenetrating radiation shield comprising:
an active shield wherein the active shield generates a directional active shield field; and
at least one passive shield having an areal density ranging from about 1 g/cm² to about 1000 g/cm² positioned within the active shield field in a relationship to the active shield wherein a radiation particle having kinetic energy traverses a path at a rate of speed and is deflected by the active shield field as the radiation particle enters the passive shield, wherein the path of the radiation particle is lengthened within the passive shield; and wherein the kinetic energy of the radiation particle and the speed of the radiation particle are decreased within the passive shield.

2. An interpenetrating radiation shield according to claim 1, wherein the radiation particle is ablated within the passive shield.

3. An interpenetrating radiation shield according to claim 1, wherein the path of the radiation particle within the passive shield is directed out of the passive shield by the active shield field.

4. An interpenetrating radiation shield according to claim 1, wherein the path of the radiation particle within the passive shield is directed further into the passive shield by the active shield field.

5. An interpenetrating radiation shield according to claim 1, wherein the radiation particle is captured within the passive shield.

6. An interpenetrating radiation shield according to claim 1, wherein the active shield field is selected from the group consisting of: an electrostatic field and a magnetic field.

7. An interpenetrating radiation shield according to claim 6, wherein the active shield is a magnetic field.

8. An interpenetrating radiation shield according to claim 1, wherein the active shield field is segmented.

9. An interpenetrating radiation shield according to claim 1, wherein the active shield is comprised of a shell having a minimum thickness of about 1 cm and emits a field strength greater than 0.1 Gauss.

10. An interpenetrating radiation shield according to claim 9, wherein the shell has a thickness of at least 100 cm and the field strength is at least 10 Gauss.

11. An interpenetrating radiation shield according to claim 9, wherein the field strength is at least 500 Gauss.

12. An interpenetrating radiation shield according to claim 1, wherein the passive shield is selected from the group consisting of: a solid, a liquid, and a gas.

13. An interpenetrating radiation shield according to claim 12, wherein the passive shield is a solid.

14. An interpenetrating radiation shield according to claim 13, wherein the solid is a foam, uniformly distributed throughout the active shield field.

15. An interpenetrating radiation shield according to claim 12, wherein the liquid has a volumetric density ranging from about 0.06 g/cm³ to about 2.0 g/cm³.

16. An interpenetrating radiation shield according to claim 12, wherein the gas has a volumetric density greater than 1×10⁻²⁰ g/cm³.

17. An interpenetrating radiation shield according to claim 1, wherein the passive shield has an areal density ranging from about 5 g/cm² to about 500 g/cm².

18. An interpenetrating radiation shield according to claim 17, wherein the passive shield has an areal density ranging from about 8 g/cm² to about 210 g/cm².

19. An interpenetrating radiation shield according to claim 1, wherein the passive shield is liquid hydrogen.

20. An interpenetrating radiation shield according to claim 1, wherein the passive shield is segmented.

21. An interpenetrating radiation shield according to claim 1, wherein the active shield is segmented.

22. An interpenetrating radiation shield according to claim 1, further comprising a passive shield surrounding the active shield field.

23. An interpenetrating radiation shield comprising:
an active shield wherein the active shield generates a directional active shield field; and
at least one passive shield having an areal density ranging from about 1 g/cm² to about 1000 g/cm² partially positioned within the active shield field in a relationship to the active shield wherein a radiation particle having kinetic energy traverses a path at a rate of speed and is deflected by the active shield field as the radiation particle enters the passive shield; wherein the path of the radiation particle is lengthened within the passive shield; and wherein the passive shield decreases the kinetic energy of the radiation particle and decreases the speed of the radiation particle, wherein the radiation particle is more susceptible to the active shield field.

24. An interpenetrating radiation shield comprising:
a magnetic active shield comprising a shell having a thickness of at least 100 cm and a field strength of at least 10 Gauss, wherein the magnetic active shield generates a directional magnetic field; and
a foam passive shield having an areal density ranging from about 1 g/cm² to about 1000 g/cm² positioned equally distributed throughout the magnetic active shield field wherein a radiation particle having kinetic energy traverses a path at a rate of speed and is deflected by the active shield magnetic field as the radiation particle enters the foam passive shield, wherein the path of the radiation particle is lengthened within the foam passive shield; and wherein the kinetic energy of the radiation particle and the speed of the radiation particle are decreased within the foam passive shield.
